(19) United States
(12) Patent Application Publication
(10) Pub. No.: US 2023/0294662 A1
(43) Pub. Date: Sep. 21, 2023

(54) APPARATUS AND METHOD FOR GENERATING VIRTUAL SOUND

(71) Applicants: Hyundai Motor Company, Seoul (KR); Kia Corporation, Seoul (KR)

(72) Inventors: Ki Chang Kim, Suwon (KR); Tae Kun Yun, Anyang (KR); Dong Chul Park, Anyang (KR); Eun Soo Jo, Hwaseong (KR); Jin Sung Lee, Hwaseong (KR)

(21) Appl. No.: 17/943,733

(22) Filed: Sep. 13, 2022

(30) Foreign Application Priority Data
Mar. 21, 2022 (KR) 10-2022-0034839

(51) Int. Cl. B60W 20/15; B60K 35/00; B60W 50/10

(52) U.S. Cl. CPC B60W 20/15; B60K 35/00; B60W 50/10; B60K 2370/157; B60W 2420/42; B60W 2510/081

(57) ABSTRACT

An apparatus and a method for generating a virtual sound to generate the virtual sound depending on a driving condition of a vehicle are provided. The apparatus comprises a detection device configured to detect vehicle environment data, a sound output device configured to play and output a virtual sound, and a processing device connected with the detection device and the sound output device. The processing device is configured to generate the virtual sound using the vehicle environment data and a big data-based sound database in a zero to hundred condition and controls the sound output device to play the generated virtual sound.

### CROSS-REFERENCE TO RELATED APPLICATION(S)

This application claims, under 35 U.S.C. § 119(a), the benefit of priority to Korean Patent Application No. 10-2022-0034839, filed in the Korean Intellectual Property Office on Mar. 21, 2022, the disclosure of which is incorporated herein by reference in its entirety.

### BACKGROUND

### Technical Field

Embodiments of the present disclosure relate to an apparatus and a method for generating a virtual sound to generate the virtual sound depending on a driving condition of a vehicle.

### Description of the Related Art

As an electrification vehicle (e.g., an electric vehicle, a hydrogen electric vehicle, or the like) drives using its electric motor, because there is no engine sound in the electrification vehicle, it is difficult for a pedestrian to recognize an approaching electrification vehicle. To address this problem, a virtual engine sound system (VESS) or an acoustic vehicle alerting system (AVAS), which generates a virtual engine sound and allows a pedestrian to recognize the virtual engine sound, has been developed and has been compulsorily installed in electrification vehicles.

The VESS or the AVAS implements an engine sound using an electronic sound generator (ESG). The ESG is mounted on a cowl top panel of the vehicle to generate an additional sound (or a structure vibration sound) using vehicle body vibration when the engine sound is generated. However, as allophone occurs in a weld part of a body cowl bracket loaded with the ESG and a cowl top cover, quality costs for structural reinforcement and vibration insulation are excessive.

### SUMMARY

The present disclosure has been made to solve the above-mentioned problems occurring in the existing technologies while advantages achieved by the existing technologies are maintained intact.

An aspect of the present disclosure provides an apparatus and a method for generating a virtual sound to generate the virtual sound in conjunction with a driving environment and accelerator pedal responsiveness in a zero to hundred condition.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for generating a virtual sound may comprise a detection device that detects vehicle environment data, a sound output device that plays and outputs the virtual sound, and a processing device connected with the detection device and the sound output device. The processing device may be configured to generate the virtual sound based on the vehicle environment data and a big data-based sound database in a zero to hundred condition and may be configured to control the sound output device to play the generated virtual sound.

The processing device may be configured to determine that a vehicle driving state meets a zero to hundred mode entry condition, when an accelerator pedal is fully operated in a stop state.

The processing device may be configured to determine accelerator pedal responsiveness based on an accelerator position sensor (APS) output signal, may be configured to calculate power for a sense of driving acceleration based on the accelerator pedal responsiveness, and may be configured to output a virtual sound control signal based on the calculated power.

The processing device may be configured to implement the virtual sound in three steps based on a vehicle speed and accelerator pedal responsiveness.

The processing device may be configured to analyze an image obtained using a camera mounted on the outside of a vehicle to estimate a driving environment and may be configured to adjust volume of the virtual sound based on the estimated driving environment.

The processing device may be configured to synthesize an animal sound with an exhaust sound to generate the virtual sound.

The processing device may be configured to synthesize the animal sound with the exhaust sound using a formant filter.

The processing device may be configured to determine impact timing of the virtual sound based on an accelerator pedal opening amount.

The sound output device may be configured to control a sound output of at least one of a woofer, an internal speaker, or an external speaker, when the virtual sound is played.

According to another aspect of the present disclosure, a method for generating a virtual sound may comprise generating the virtual sound based on vehicle environment data and a big data-based sound database in a zero to hundred condition and controlling a sound output device to play the virtual sound.

The generating of the virtual sound may comprise determining that a vehicle driving state meets a zero to hundred mode entry condition, when an accelerator pedal is fully operated in a stop state.

The generating of the virtual sound may comprise determining accelerator pedal responsiveness based on an APS output signal, calculating power for a sense of driving acceleration based on the accelerator pedal responsiveness, and outputting a virtual sound control signal based on the calculated power.

The generating of the virtual sound may comprise implementing the virtual sound in three steps based on a vehicle speed and accelerator pedal responsiveness.

The generating of the virtual sound may comprise analyzing an image obtained using a camera mounted on the outside of a vehicle to estimate a driving environment and adjusting volume of the virtual sound based on the estimated driving environment.

The generating of the virtual sound may comprise synthesizing an animal sound with an exhaust sound to generate the virtual sound.

The generating of the virtual sound may comprise synthesizing the animal sound with the exhaust sound using a formant filter.

The controlling of the sound output device may comprise determining impact timing of the virtual sound based on an accelerator pedal opening amount.

The controlling of the sound output device may comprise controlling a sound output of at least one of a woofer, an internal speaker, or an external speaker, when the virtual sound is played.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of an apparatus for generating a virtual sound according to exemplary embodiments of the present disclosure;

FIG. 2 is a flowchart illustrating a process of controlling a virtual sound according to exemplary embodiments of the present disclosure;

FIG. 3 is a drawing schematically illustrating a virtual driving simulation construction process according to exemplary embodiments of the present disclosure;

FIG. 4 is a drawing illustrating a process of tuning a virtual sound in a virtual driving simulation device according to exemplary embodiments of the present disclosure;

FIG. 5 is a drawing illustrating a process of implementing an exhaust sound according to exemplary embodiments of the present disclosure;

FIG. 6 is a drawing illustrating sound source mixing logic according to exemplary embodiments of the present disclosure; and

FIG. 7 is a flowchart illustrating a method for generating a virtual sound according to exemplary embodiments of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

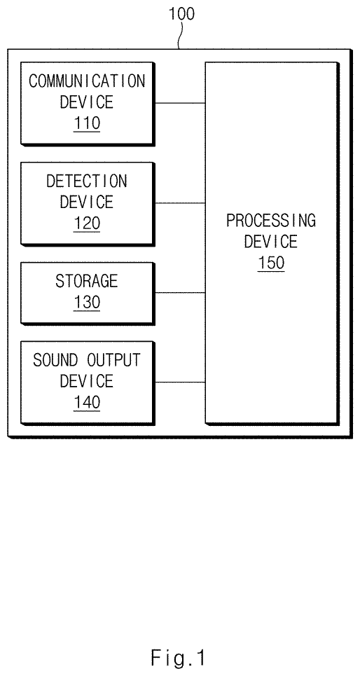

FIG. 1 is a block diagram illustrating a configuration of an apparatus for generating a virtual sound according to embodiments of the present disclosure.

An apparatus 100 for generating a virtual sound may be configured to be loaded into an electrification vehicle, such as an electric vehicle (EV), a plug-in hybrid electric vehicle (PHEY), and/or a hybrid electric vehicle (HEY), which travels using an electric motor. The apparatus 100 for generating the virtual sound may be configured to design a virtual sound based on a hearing experience of a user and may be configured to personalize the virtual sound by means of tone adjustment and accelerator pedal responsiveness adjustment.

Referring to FIG. 1, the apparatus 100 for generating the virtual sound may comprise a communication device 110, a detection device 120, a storage 130, a sound output device 140, and a processing device 150.

The communication device 110 may be configured to assist the apparatus 100 to communicate with electronic control units (ECUs) loaded into the electrification vehicle (hereinafter, referred to as a “vehicle”). The communication device 110 may comprise a transceiver which transmits and receives a controller area network (CAN) message using a CAN protocol. The communication device 110 may be configured to assist the apparatus 100 to communicate with an external electronic device (e.g., a terminal, a server, and the like). The communication device 110 may comprise a wireless communication circuit, a wired communication circuit, and/or the like.

The detection device 120 may be configured to detect driving information and/or environmental information (i.e., vehicle interior environment information and/or vehicle exterior environment information). The detection device 120 may be configured to detect driving information such as a driver steering angle (or a steering wheel steering angle), a tire steering angle (or a tie rod), a vehicle speed, motor revolutions per minute (RPM), a motor torque, and/or an accelerator pedal opening amount using sensors and/or ECUs loaded into the vehicle. An accelerator position sensor (APS), a steering angle sensor, a microphone, an image sensor, a distance sensor, a wheel speed sensor, an advanced driver assistance system (ADAS) sensor, a 3-axis accelerometer, an inertial measurement unit (IMU), and/or the like may be used as the sensors. The ECUs may be a motor control unit (MCU), a vehicle control unit (VCU), and/or the like.

The storage 130 may comprise a big data-based sound database (DB). The big data-based sound DB may comprise a future-oriented DB, a human voice DB, a natural sound DB, an animal sound DB, and an exhaust sound DB. The future-oriented DB may comprise a spaceship sound or the like. The human voice DB may comprise a family voice, an actor voice, and the like. The natural sound DB may comprise a sound of waves, a sound of heavy rain, a sound of wind, and the like. Furthermore, the animal sound DB may comprise a tiger sound, a lion sound, and the like. The exhaust sound DB may comprise a backfire sound or the like. The storage 130 may be configured to store a sound source of a virtual sound such as a tire slip sound, a warning sound, a driving sound, an acceleration sound, and/or a cornering sound.

The storage 130 may be configured to store an emotion recognition model, a sound design algorithm, a volume setting algorithm, volume control logic, sound equalizer logic, and/or the like. The emotion recognition model may be implemented based on a sound-based emotion factor and a dynamic characteristic-based emotion factor. The sound-based emotion factor may comprise acceleration and deceleration of downshift emotion, slip and pedal responsiveness of drift emotion, tire slip and an exhaust sound of drive and response emotion, and/or the like. The dynamic characteristic-based emotion factor may comprise vibration of sound feedback emotion, body stiffness of ride comfort emotion, a chassis balance of maneuverability emotion, and/or the like. The sound-based emotion factor and the dynamic characteristic-based emotion factor may be derived by previously evaluating a correlation between vehicle kinetic performance and driving emotion. As an example, a slip upon stop acceleration, a jerk upon shift, and rapid acceleration wide open throttle (WOT) emotional factor correlation may be evaluated by a change in vehicle speed and motor RPM over time. A dynamic characteristic emotional factor correlation except for maneuverability upon cornering may be analyzed by a change in yaw rate and side slip angle over time. The sound design algorithm may comprise high performance sound equalizer logic in which engine sound equalizer (ESE) logic considering an engine sound is added to an existing active sound design (ASD) function, by means of a target profile and engine information (e.g., an RPM, a throttle opening amount, a torque, and/or the like).

The storage 130 may be a non-transitory storage medium which stores instructions executed by the processing device 150. The storage 130 may comprise at least one of storage media such as a random access memory (RAM), a static RAM (SRAM), a read only memory (ROM), a programmable ROM (PROM), an electrically erasable and programmable ROM (EEPROM), an erasable and programmable ROM (EPROM), a hard disk drive (HDD), a solid state disk (SSD), an embedded multimedia card (eMMC), a universal flash storage (UFS), and/or a web storage.

The sound output device 140 may be configured to play and output a virtual sound to speakers mounted on the inside and/or outside of the vehicle. The sound output device 140 may be configured to play and output a sound source which is previously stored or is streamed in real time. The sound output device 140 may comprise an amplifier, a sound playback device, and the like. The sound playback device may be configured to adjust and play volume, a tone (or sound quality), a sound image, and the like of the sound under an instruction of the processing device 150. The sound playback device may comprise a digital signal processor (DSP), microprocessors, and/or the like. The amplifier may be configured to amplify an electrical signal of the sound played from the sound playback device.

The processing device 150 may be electrically connected with the respective components 110 to 140. The processing device 150 may comprise at least one of processing devices such as an application specific integrated circuit (ASIC), a digital signal processor (DSP), programmable logic devices (PLD), field programmable gate arrays (FPGAs), a central processing unit (CPU), microcontrollers, and/or microprocessors.

The processing device 150 may be configured to detect (or obtain) driver manipulation information, vehicle interior environment information, vehicle exterior environment information, and the like by means of the detection device 120, while the vehicle is traveling. Herein, the driver manipulation information may comprise a driver steering angle, a tire steering angle, and/or the like. The vehicle interior environment information may comprise information such as an indoor air temperature, an accelerator pedal opening amount, a wheel speed-based vehicle speed, and/or a throttle opening amount. The vehicle exterior environment information may comprise an outdoor air temperature, a GPS-based vehicle speed, and/or the like. The processing device 150 may be configured to design a virtual sound based on the driver manipulation information, the vehicle interior environment information, the vehicle exterior environment information, and/or the like and may be configured to adjust a tone, volume, and the like of the virtual sound.

The processing device 150 may be configured to detect manipulation of a driver using the detection device 120, while the vehicle is traveling. In other words, the processing device 150 may be configured to detect a degree to which the accelerator pedal is depressed (or an accelerator pedal position, an amount of accelerator pedal depressed, an amount of accelerator pedal pressure, or the like). The processing device 150 may be configured to determine a vehicle driving state based on the degree to which the accelerator pedal is depressed, that is, an APS sensing value (or an APS output signal). When the accelerator pedal is fully depressed in a state where the vehicle is stopped, the processing device 150 may be configured to determine that the vehicle driving state meets a zero to hundred condition (or a rapid acceleration driving condition). Herein, zero to hundred refers to a time taken to fully depress the accelerator pedal in a stopped state up to 100 km/h (or 60 miles/h).

The processing device 150 may be configured to generate a virtual sound (or an emotional sound, a zero to hundred sound, an acceleration sound, or the like) in conjunction with a driving environment (e.g., a country road, a downtown, the inside of tunnel, or the like), a vehicle speed, an RPM, accelerator pedal responsiveness, and/or the like in the zero to hundred condition. Furthermore, the processing device 150 may be configured to control a virtual sound using the accelerator pedal responsiveness and the big data-based sound DB. At this time, the processing device 150 may be configured to use an emotional sound design algorithm. The processing device 150 may be configured to first select four driving sound emotion models capable of experiencing a high-performance sound to implement the emotional sound design algorithm. The four driving sound emotion models may be divided into SPORTY, HIGH PERFORMANCE, touring car racing (TCR), and PERSONAL. Herein, PERSONAL may propose an emotional sound by additionally using an algorithm considering personalization. Next, the processing device 150 may be configured to proceed with optimization by means of driving sound customizing for each volume and register to implement a high-performance vehicle emotion model. Finally, the processing device 150 may be configured to implement a zero to hundred sound in three steps by means of a volume and tone design to provide an impact sound.

The processing device 150 may be configured to generate an acceleration sound in three steps based on accelerator pedal responsiveness and a vehicle speed. In other words, the processing device 150 may be configured to divide the rapid acceleration driving condition into three steps and may be configured to control an acceleration sound depending on a rapid acceleration driving step (or a zero to hundred step). A first step of rapid acceleration refers to a state where the accelerator pedal is fully depressed and where the vehicle speed is less than a first acceleration interval (greater than 0 kph and less than or equal to 100 kph). A second step of rapid acceleration is a boost mode where the accelerator pedal is fully depressed once more in a state where the accelerator pedal is fully depressed and refers to a state where the vehicle speed is less than a second acceleration interval (greater than 100 kph and less than or equal to 160 kph). A third step of rapid acceleration refers to a state where the accelerator pedal responsiveness is the boost mode and where the vehicle speed is less than a third acceleration interval (greater than 160 kph and less than or equal to 200 kph). Thereafter, the processing device 150 may be configured to generate a virtual sound according to the rapid acceleration driving condition (or the zero to hundred condition) of the vehicle.

The processing device 150 may be configured to control the sound output device 140 to play and output the sound in the zero to hundred condition. The virtual sound may be a sound in which the sound of a tiger growling (i.e., an animal sound) and an engine backfire sound (i.e., an exhaust sound) of an actual vehicle are synthesized with each other.

The processing device 150 may be configured to separately play a post-combustion sound based on a post-combustion signal of the vehicle. In a general post-combustion sound playback scheme, a sound source is located in a real exhaust manifold such that the driver recognizes a sound from the rear of the vehicle. The present embodiment may be configured to address a problem in which the arrangement of the sound playback device is limited due to a limitation of a vehicle package and may be configured to use a sound division playback technology to provide various patterns of post-combustion sounds As an example, unlike general music playback, the present embodiment may be configured to divide a channel of playing a post-combustion sound to decrease sound pressure of the sound playback device located at the front of the vehicle and increase sound pressure of the sound playback device located at the rear of the vehicle, thus providing emotion differentiated from the post-combustion sound of the internal combustion engine. Furthermore, the present disclosure may be configured to adjust a delay for each channel to adjust a location where sounds meet with each other, thus providing emotion differentiated from the post-combustion sound of the internal combustion engine. As such, as the sound division playback technology is used, because the freedom of design is increased, it is possible to play a variety of original virtual sounds.

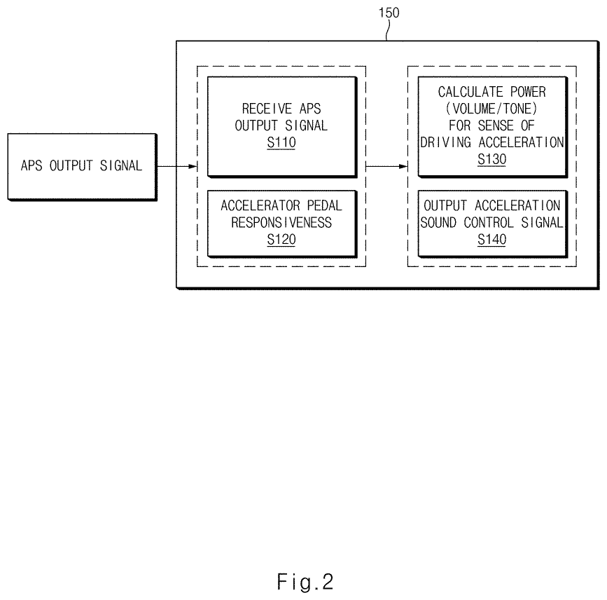

FIG. 2 is a flowchart illustrating a process of controlling a virtual sound according to embodiments of the present disclosure.

A processing device 150 of FIG. 1 may be configured to perform a zero to hundred sound emotion design by means of APS control. The APS control is a function of adjusting an accelerator pedal opening amount, which is a process for a sound design with regard to a constant speed or acceleration driving condition of an actual vehicle.

In S110, the processing device 150 may be configured to receive an APS output signal output from an APS. In S120, the processing device 150 may be configured to determine accelerator pedal responsiveness based on the received APS output signal. The accelerator pedal responsiveness may be divided into “middle”, “full”, and “boost”.

In S130, the processing device 150 may be configured to calculate power, that is, volume and a tone for a sense of driving acceleration based on the accelerator pedal responsiveness. In S140, the processing device 150 may be configured to output an acceleration sound control signal based on the calculated power.

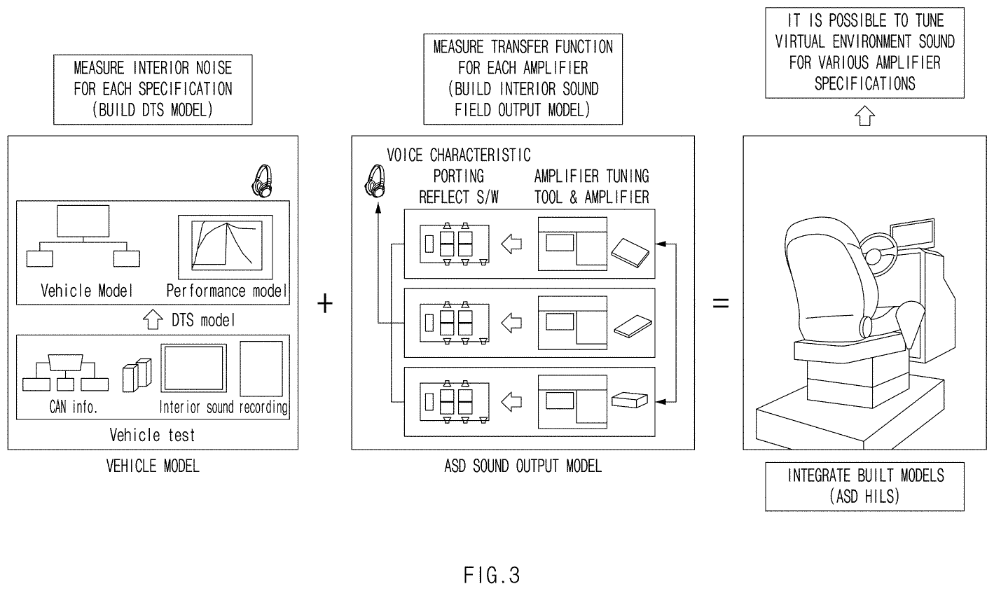

FIG. 3 is a drawing schematically illustrating a virtual driving simulation construction process according to embodiments of the present disclosure.

Referring to FIG. 3, a virtual driving simulation model (or logic) may be developed by measuring actual vehicle interior noise measurement data and a transfer function for each amplifier for actual vehicle driving simulation in a virtual environment. In detail, interior noise for each vehicle specification may be measured and a vehicle model may be generated using the measured data. A transfer function for each amplifier may be measured, and an interior sound field output model, that is, an ASD sound output model may be generated based on the measured transfer function for each amplifier. The generated vehicle model and the generated ASD sound output model may be integrated with each other to construct a virtual driving simulation model, that is, ASD hardware in loop simulation (HiLS). The virtual driving simulation model may be configured to tune a virtual environment sound for various amplifier specifications.

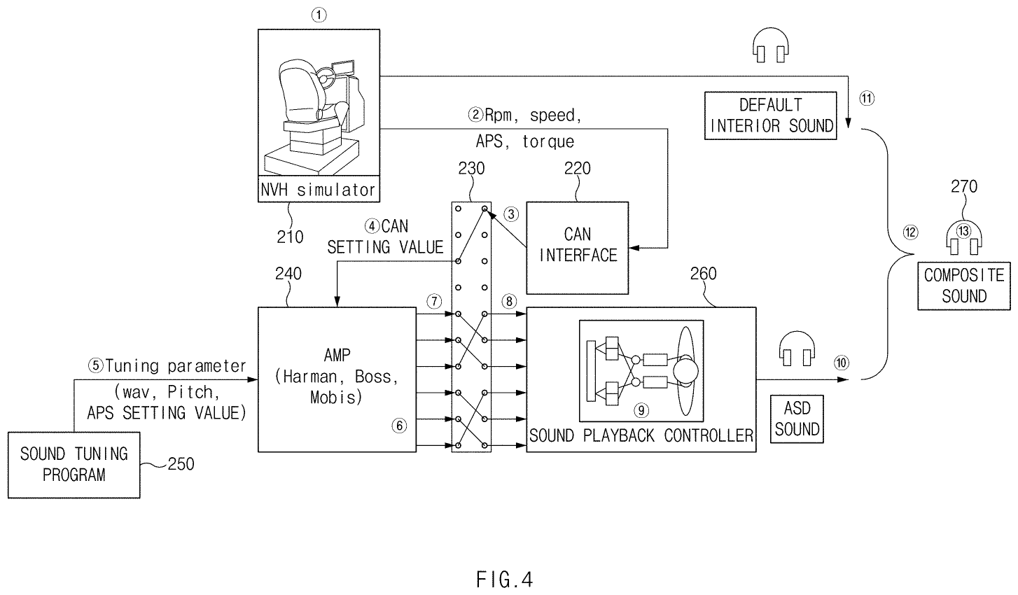

FIG. 4 is a drawing illustrating a process of tuning a virtual sound in a virtual driving simulation device according to embodiments of the present disclosure.

Referring to FIG. 4, when an accelerator pedal is manipulated, a noise, vibration, harshness (NVH) simulator 210 may be configured to detect an amount of accelerator pedal pressure (\hat{1}). The NVH simulator 210 may be configured to calculate a parameter according to the amount of accelerator pedal pressure (or a parameter calculated in a simulator model) and may be configured to deliver the calculated parameter to a CAN interface 220 (\hat{2}). The parameter may comprise an RPM, a speed, an accelerator pedal sensor (APS) value, a torque, and/or the like.

The CAN interface 220 may be configured to deliver the CAN signal including the parameter calculated by the NVH simulator 210 to a connection terminal 230 (\hat{3}). The connection terminal 230 may be configured to deliver the CAN signal to an AMP 240 (\hat{4}). The AMP 240 may be configured to receive a tuning parameter of a sound tuning program 250 (\hat{5}).

The AMP 240 may be configured to calculate an output signal according to the turning parameter and the CAN signal (\hat{6}). The AMP 240 may be configured to deliver the calculated output signal to the connection terminal 230 (\hat{7}). The connection terminal 230 may be configured to deliver the output signal to a sound playback controller 260 (\hat{8}).

The sound playback controller 260 may be configured to convert six or seven output signals input from the connection terminal 230 into a stereo sound (\hat{9}). The sound playback controller 260 may be configured to output the converted stereo sound (i.e., an ASD sound) (\textcircled{10}).

The NVH simulator 210 may be configured to output a sound (or a default interior sound) recorded in the actual vehicle (\textcircled{11}). A headset 270 may be configured to synchronize and synthesize the sound output from the NVH simulator 210, that is, the default sound with the stereo sound output from the sound playback controller 260, that is, the ASD sound in real time (\textcircled{12}). The headset 270 may be configured to output the synthesized stereo sound (or a composite sound) (\textcircled{13}). The NVH simulator 210 may be configured to compare the composite sound with a predetermined target sound, may be configured to select the composite sound when the composite sound is identical to the target sound, and may be configured to feed back the compared result to the ASD device 260 to reflect it in generating the ASD sound, when the composite sound is not identical to the target sound, thus repeating it until the composite sound identical to the target sound is output. In this case, the target sound may be a composite sound in an ideal situation, which may deteriorate to be heard, when the target sound is output from the vehicle. Thus, an embodiment of the present disclosure may correct the composite sound output actually to the vehicle to be close to the target sound.

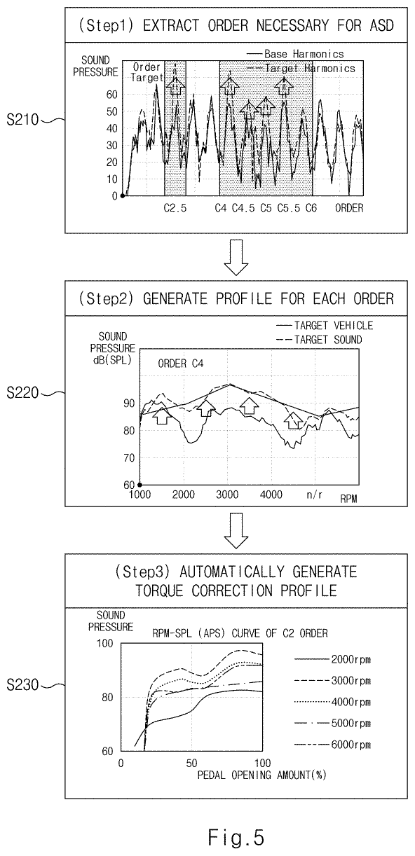

FIG. 5 is a drawing illustrating a process of implementing an exhaust sound according to embodiments of the present disclosure.

To implement an exhaust sound, in S210, a processing device 150 of an apparatus 100 for generating a virtual sound in FIG. 1 may be configured to extract an order necessary for a design (i.e., an ASD). In other words, the processing device 150 may be configured to extract a multi-step order. At this time, the processing device 150 may be configured to compare sound pressure of a target sound for each order with sound pressure of a target vehicle sound to select an order necessary for a sound design. The processing device 150 may be configured to use a sound pressure curve according to RPM of a target vehicle for each order.

In S220, the processing device 150 may be configured to generate a profile for each extracted order. In other words, the processing device 150 may be configured to calculate an interval sound pressure difference by means of a linear regression analysis of a target sound for each order and a target vehicle sound to generate a sound pressure file.

In S230, the processing device 150 may be configured to automatically generate a torque correction profile and may be configured to implement a sound using the generated torque correction profile. The processing device 150 may be configured to generate an accelerator pedal opening amount curve according to RPM for each order and may be configured to select an accelerator pedal opening amount curve according to representative RPM. The processing device 150 may be configured to generate a torque correction profile based on the selected accelerator pedal opening amount curve according to the representative RPM.

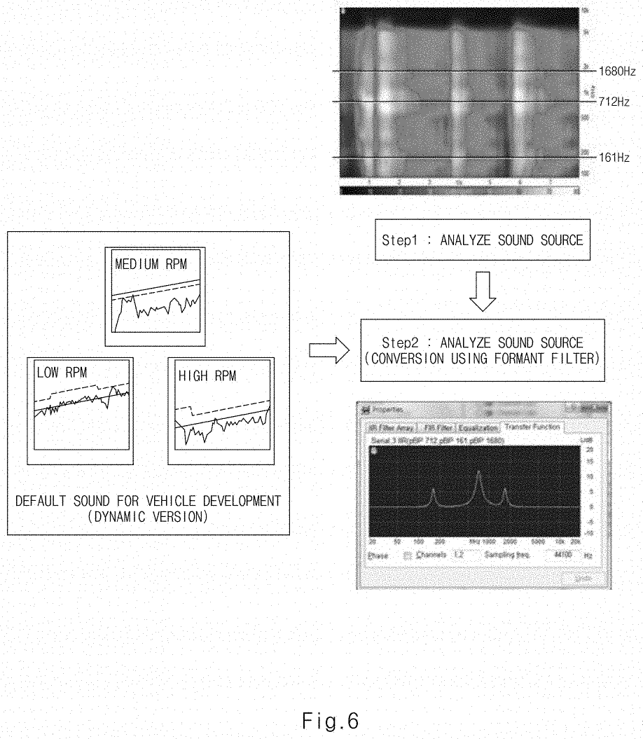

FIG. 6 is a drawing illustrating sound source mixing logic according to embodiments of the present disclosure.

First of all, a processing device 150 of FIG. 1 may be configured to analyze a sound source of an animal sound matched with a previously selected vehicle concept. The processing device 150 may be configured to divide an animal voice signal in the animal sound into three frequency domains using fast Fourier transform (FFT). The processing device 150 may be configured to extract a feature vector in each divided frequency domain and may be configured to assign a weight for each frequency to the extracted feature vector. The processing device 150 may be configured to emphasize an animal voice signal formant based on a human auditory experience model.

The processing device 150 may be configured to perform sound quality synthesis of an animal sound, which passes through a sound source analysis, and a default sound for vehicle development using a formant filter. The processing device 150 may be configured to convert an analog animal voice signal into a digital animal voice signal. The processing device 150 may be configured to synthesize animal sounds and exhaust sounds of three frequency domains extracted by means of a sound source analysis in conjunction with a vehicle speed (or a low speed, a medium speed, and a high speed) and an RPM. The processing device 150 may be configured to determine impact timing based on the accelerator pedal opening amount. The processing device 150 may be configured to generate a volume correction profile based on a driving environment, for example, a country road, the inside of a tunnel, or the like. Furthermore, the processing device 150 may be configured to control a zero to hundred sound depending on the driving environment. For example, the processing device 150 may be configured to add a woofer or may be configured to select interior and exterior speakers (or an internal speaker and an external speaker), depending on the driving environment.

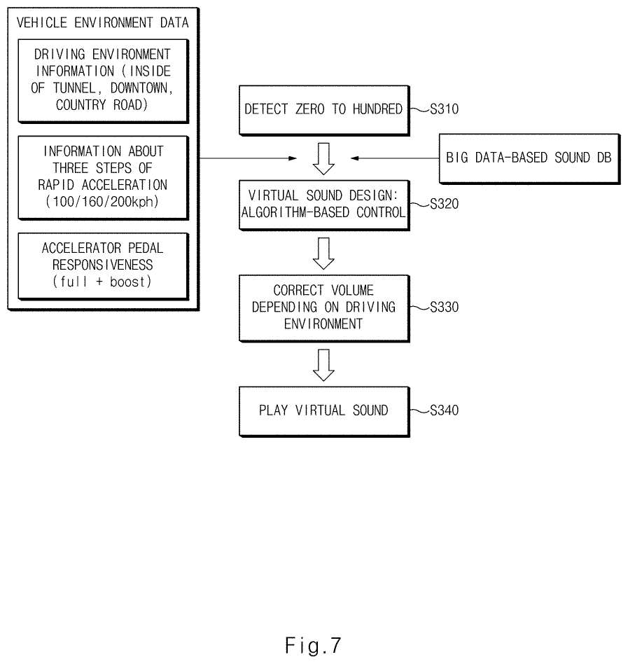

FIG. 7 is a flowchart illustrating a method for generating a virtual sound according to embodiments of the present disclosure.

In S310, a processing device 150 of an apparatus 100 for generating a virtual sound in FIG. 1 may be configured to detect zero to hundred of a vehicle. When the accelerator pedal is fully operated in a stop state, the processing device 150 may be configured to determine that a vehicle driving state meets a zero to hundred mode entry condition.

When zero to hundred is detected, in S320, the processing device 150 may be configured to design a virtual sound using vehicle environment data and a big data-based sound DB. The vehicle environment data may comprise a driving environment, a rapid acceleration driving step, a vehicle speed, an RPM, accelerator pedal responsiveness, and/or the like. The processing device 150 may be configured to obtain an image using a camera on the outside of the vehicle. The processing device 150 may be configured to analyze an image obtained by the camera to estimate (or recognize) a driving environment, for example, the inside of a tunnel, a downtown, a country road, or the like. At this time, the processing device 150 may be configured to use an image analysis algorithm (e.g., a visual convolutional neural network (CNN) or the like) based on an artificial neural network. The processing device 150 may be configured to receive a CAN signal including vehicle environment data through a CAN interface. The CAN interface may comprise a CAN player which performs CAN signal transmission and reception between the processing device 150 and an AMP. The processing device 150 may be configured to synthesize an animal sound with an exhaust sound in conjunction with vehicle environment data using an emotional sound design algorithm to generate a virtual sound (or a zero to hundred sound). The processing device 150 may be configured to use a formant filter when synthesizing the animal sound with the exhaust sound.

In S330, the processing device 150 may be configured to correct volume of the virtual sound designed according to the driving environment. When the driving environment (or the driving place) is recognized as a country road using a zero to hundred volume correction algorithm, the processing device 150 may be configured to adjust volume to +3 dB. When the driving environment (or the driving place) is recognized as the inside of a tunnel, the processing device 150 may be configured to adjust volume to +7 dB.

In S340, the processing device 150 may be configured to play the corrected virtual sound. The processing device 150 may be configured to play and output the virtual sound using a sound output device 140 of FIG. 1. The sound output device 140 may be configured to control at least one of a woofer, an internal speaker, or an external speaker depending on a control command of the processing device 150.

Embodiments of the present disclosure may be configured to generate a virtual sound in conjunction with a driving environment and accelerator pedal responsiveness in a zero to hundred condition, thus providing a driver with fun and emotional satisfaction.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims. Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An apparatus for generating a virtual sound, the apparatus comprising:
a detection device configured to detect vehicle environment data;
a sound output device configured to play and output the virtual sound; and
a processing device, connected with the detection device and the sound output device, configured to:
generate the virtual sound based on the vehicle environment data and a big data-based sound database in a zero to hundred condition; and
control the sound output device to play the generated virtual sound.

2. The apparatus of claim 1, wherein the processing device is configured to determine that a vehicle driving state meets a zero to hundred mode entry condition, when an accelerator pedal is fully operated in a stop state.

3. The apparatus of claim 1, wherein the processing device is configured to:
determine accelerator pedal responsiveness based on an accelerator position sensor (APS) output signal,
calculate power for a sense of driving acceleration based on the accelerator pedal responsiveness; and
output a virtual sound control signal based on the power.

4. The apparatus of claim 1, wherein the processing device is configured to implement the virtual sound in three steps based on a vehicle speed and accelerator pedal responsiveness.

5. The apparatus of claim 1, wherein the processing device is configured to:
analyze an image obtained using a camera mounted on the outside of a vehicle to estimate a driving environment; and
adjust volume of the virtual sound based on the estimated driving environment.

6. The apparatus of claim 1, wherein the processing device is configured to synthesize an animal sound with an exhaust sound to generate the virtual sound.

7. The apparatus of claim 6, wherein the processing device is configured to synthesize the animal sound with the exhaust sound using a formant filter.

8. The apparatus of claim 1, wherein the processing device is configured to determine impact timing of the virtual sound based on an accelerator pedal opening amount.

9. The apparatus of claim 1, wherein the sound output device is configured to control a sound output of at least one of a woofer, an internal speaker, or an external speaker, when the virtual sound is played.

10. A method for generating a virtual sound, the method comprising, by a processing device:
generating the virtual sound based on vehicle environment data and a big data-based sound database in a zero to hundred condition; and
controlling a sound output device to play the virtual sound.

11. The method of claim 10, wherein the generating of the virtual sound comprises:
determining, by the processing device, that a vehicle driving state meets a zero to hundred mode entry condition, when an accelerator pedal is fully operated in a stop state.

12. The method of claim 10, wherein the generating of the virtual sound comprises, by the processing device:
determining accelerator pedal responsiveness based on an APS output signal;
calculating power for a sense of driving acceleration based on the accelerator pedal responsiveness; and
outputting a virtual sound control signal based on the power.

13. The method of claim 10, wherein the generating of the virtual sound comprises:
implementing, by the processing device, the virtual sound in three steps based on a vehicle speed and accelerator pedal responsiveness.

14. The method of claim 10, wherein the generating of the virtual sound comprises, by the processing device:
analyzing an image obtained using a camera mounted on the outside of a vehicle to estimate a driving environment; and
adjusting volume of the virtual sound based on the estimated driving environment.

15. The method of claim 10, wherein the generating of the virtual sound comprises:
synthesizing, by the processing device, an animal sound with an exhaust sound to generate the virtual sound.

16. The method of claim 15, wherein the generating of the virtual sound comprises:
synthesizing, by the processing device, the animal sound with the exhaust sound using a formant filter.

17. The method of claim 10, wherein the controlling of the sound output device comprises:
determining, by the processing device, impact timing of the virtual sound based on an accelerator pedal opening amount.

18. The method of claim 10, wherein the controlling of the sound output device comprises:
controlling, by the processing device, a sound output of at least one of a woofer, an internal speaker, or an external speaker, when the virtual sound is played.
